(19) United States
(12) Patent Application Publication
(10) Pub. No.: US 2018/0074998 A1
(43) Pub. Date: Mar. 15, 2018

(54) VISUAL FEEDBACK FOR BROKEN TEXT SELECTION

(71) Applicant: MICROSOFT TECHNOLOGY LICENSING, LLC, Redmond, WA (US)

(72) Inventors: Harish Dhawan, Hyderabad (IN); Rahul Dhaundiyal, Hyderabad (IN); Jitendra Kumar, Hyderabad (IN)

(73) Assignee: MICROSOFT TECHNOLOGY LICENSING, LLC, Redmond, WA (US)

(21) Appl. No.: 15/264,079

(22) Filed: Sep. 13, 2016

(51) Int. Cl. G06F 17/21; G06F 17/27; G06F 9/54

(52) U.S. Cl. CPC G06F 17/212; G06F 3/04842; G06F 9/542; G06F 17/2775

(57) ABSTRACT

Bi-directional text contains text in both directionalities, right to-left and left-to-right. When a document includes bi-directional text a user selection of the text may visually appear continuous, but it may be logically broken. Embodiments are directed to provision of visual feedback for such a broken text selection. For example, bi-directional text may be detected within a document, where the bi-directional text includes right-to-left text and left-to-right text that meet at a boundary. In response to a selection within the document that spans the boundary such that the selection includes a portion of the right-to-left text and a portion of the left-to-right text, the selection may be determined to be logically broken. An amount of additional text to be selected within the document in order to make the selection logically continuous may be determined, and a visual indicator may be provided to identify the additional text to be selected.

### BACKGROUND

Bi-directional text is a form of text that contains text in both text directionalities, right-to-left (RTL) and left-to-right (LTR). Bi-directional text generally involves text containing characters from different types of alphabets. For example, the text may include both English that has LTR text directionality and Arabic or Hebrew that has RTL text directionality. In other examples, bi-directional text may also refer to boustrophedon, which is changing text directionality in each row.

When working with bi-directional text within a document it may be possible for a user to select a portion of the text which visually appears continuous, but is logically broken. For example, broken text selection may most often occur at a boundary of the LTR and RTL text. When a user selects and subsequently performs operations, such as a formatting change or a cut and paste operation, on the logically broken text, the result may not always be as desired.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to provision of visual feedback for a broken text selection. Bi-directional text may be detected within a document, where the bi-directional text includes right-to-left text and left-to-right text that meet at a boundary. In response to a selection within the document that spans the boundary such that the selection includes a portion of the right-to-left text and a portion of the left-to-right text, the selection may be determined to be logically broken. An amount of additional text to be selected within the document in order to make the selection logically continuous may be determined, and a visual indicator may be provided to identify the additional text to be selected within the document in order to make the selection logically continuous based on the determination.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIGS. 1A-C include display diagrams illustrating example network environments where provision of visual feedback for broken text selection may be implemented;

FIGS. 2A-B include display diagrams illustrating an example of a broken text selection and provision of visual feedback in response to the broken text selection;

FIG. 3 includes a display diagram illustrating another example of a broken text selection and provision of visual feedback in response to the broken text selection;

FIGS. 4A-B include display diagrams illustrating an example user experience configuration for provision of visual feedback in response to a broken text selection;

FIG. 5 includes a display diagram illustrating another example user experience configuration for provision of visual feedback in response to a broken text selection;

FIG. 6 is a networked environment, where a system according to embodiments may be implemented;

FIG. 7 is a block diagram of an example general purpose computing device, which may be used to provide visual feedback for broken text selection; and

FIG. 8 illustrates a logic flow diagram of a method to provide visual feedback for broken text selection, according to embodiments.

### DETAILED DESCRIPTION

As briefly described above, embodiments are directed to provision of visual feedback for a broken text selection. Bi-directional text may be detected within a document, where the bi-directional text includes right-to-left text and left-to-right text that meet at a boundary. In response to a selection within the document that spans the boundary such that the selection includes a portion of the right-to-left text and a portion of the left-to-right text, the selection may be determined to be logically broken. An amount of additional text to be selected within the document in order to make the selection logically continuous may be determined, and a visual indicator may be provided to identify the additional text to be selected within the document in order to make the selection logically continuous based on the determination. Additionally, one of a dialog box notification and a toolbar notification may be provided to alert a user that the selection is logically broken, where the notification may include an option to automatically select the additional text identified in order to make the selection continuous. In further embodiments, visual feedback for a broken text selection of vertical bi-directional text may be provided in a similar manner as described above for horizontal, bi-directional text.

In the following detailed description, references are made to the accompanying drawings that form a part hereof and in which are shown by way of illustrations, specific embodiments, or examples. These aspects maybe combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components to provide visual feedback in response to the broken text selection. Examples of platforms include, but arc not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

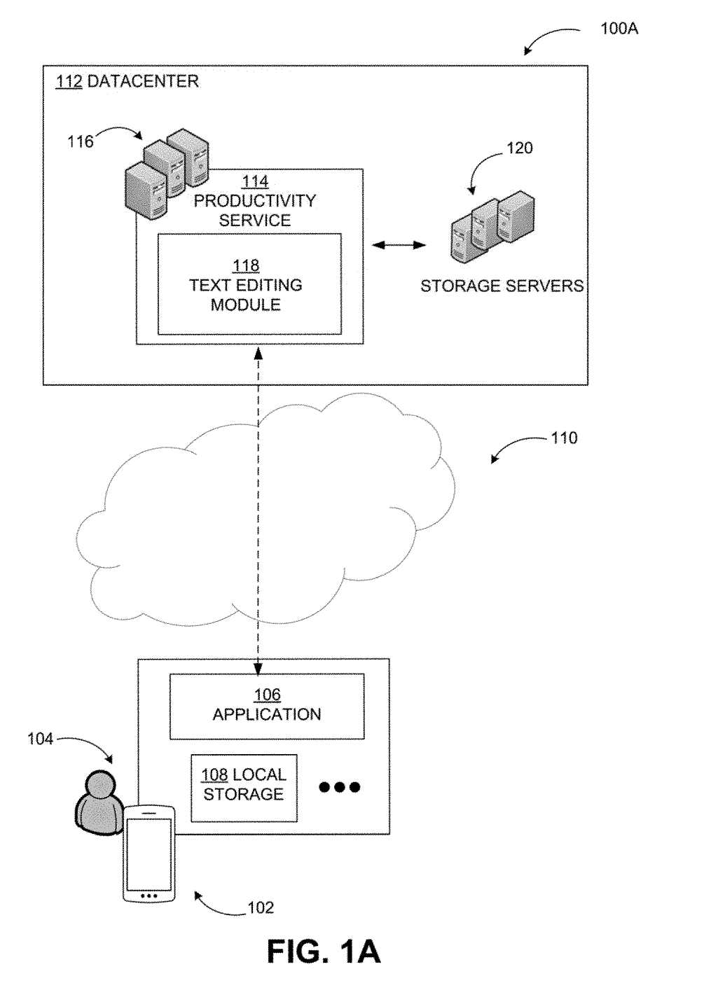

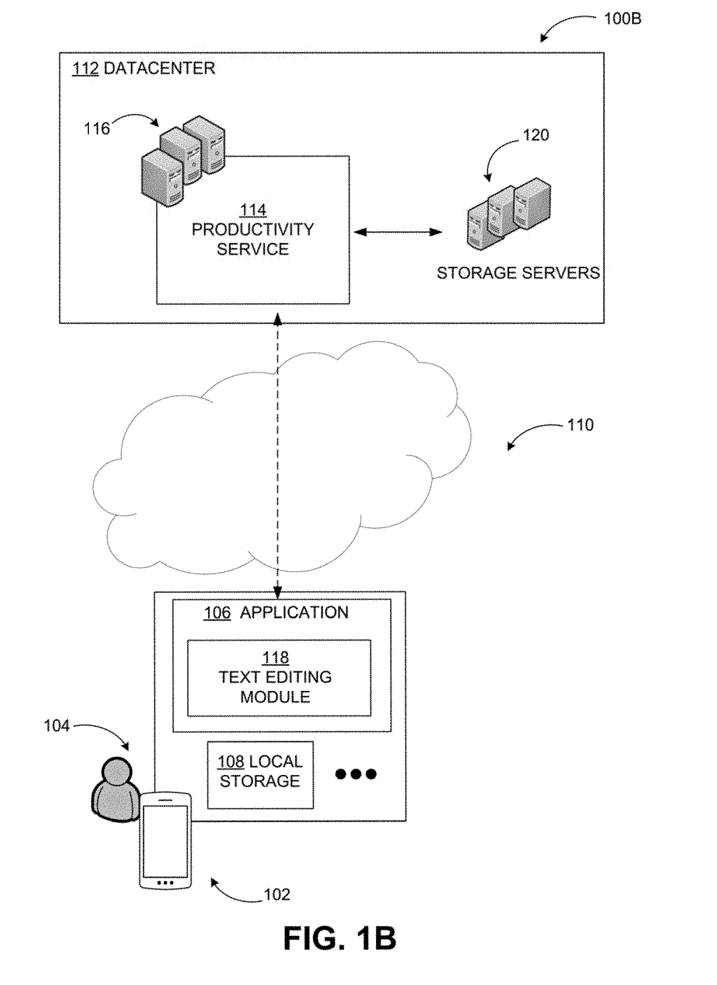

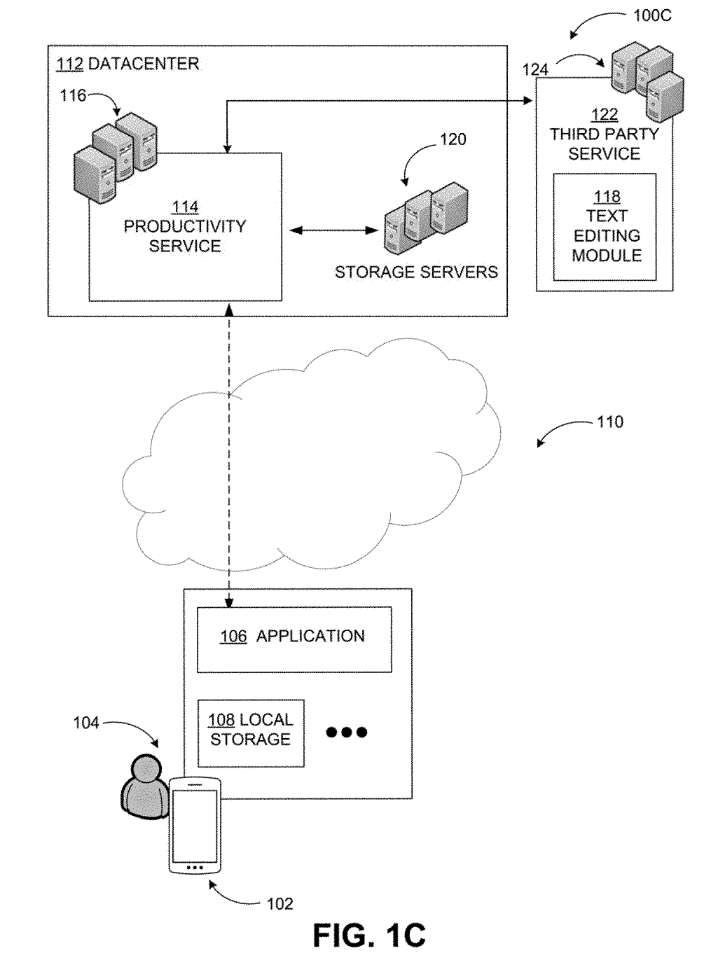

FIGS. 1A-C include display diagrams illustrating example network environments where provision of visual feedback for broken text selection may be implemented. As illustrated in diagrams 100A-C, an example system may include a datacenter 112 hosting a cloud-based productivity service 114 configured to enable users to create, edit, and/or share content among multiple devices and across a variety of platforms. The datacenter 112 may include one or more processing servers 116 configured to execute the productivity service 114, among other components. The datacenter 112 may also include one or more storage servers 120 configured to manage one or more data stores comprising data associated with the productivity service 114. As described herein, the productivity service 114 may be implemented as software, hardware, or combinations thereof.

In some embodiments, the productivity service 114 may be configured to interoperate with various applications. For example, as illustrated in the diagrams 100A-C, the user 104 may execute a thin (e.g., a web browser) or a thick (e.g., a locally installed client application) version of an application 106 through a device 102 with which the productivity service 114 may be configured to integrate and interoperate with over one or more networks, such a network 110. The application 106 may be an application hosted by the productivity service 114 including a word-processing application, a presentation application, a notebook application, a spreadsheet application, and/or a communication application, for example. The device 102 mas include a desktop computer, a laptop computer, a tablet computer, a vehicle mount computer, a smart phone, or a wearable computing device, among other similar devices. A communication interface may facilitate communication between the productivity service 114 and the application 106 over the network 110.

In one embodiment, as illustrated in diagram 100A, at least one of the processing servers 116 may be operable to execute a text editing module 118 of the productivity service 114, where the text editing module 118 may be integrated with the productivity service 114 to detect and provide visual feedback for a broken text selection. In another embodiment, as illustrated in diagram 100B, the application 100 may be operable to execute the text editing module 118, where the text editing module 118 may be integrated with the application 106. In a further embodiment, as illustrated in diagram 100C, the text editing module 118 may be a separate module associated with and/or executed by one or more processing servers 124 of a third party service 122 configured to serve multiple applications, such as the application 106 of the productivity service 114.

In an example embodiment, the text editing module 118 may be configured to detect bi-directional text within a document that is being processed by the application 106. The bi-directional text may include right-to-left text and left-to-right text that meet at a boundary. For example, the bi-directional text may include one or more different types of alphabets (e.g., Hebrew and English) and/or boustrophedon. The user 104 may make a selection within the document. If the selection spans the boundary such that the selection includes a portion of the right-to-left text and a portion of the left-to-right text, the text editing module 118 may determine that the selection is logically broken.

For example, there may he two types of layouts, a visual layout which is the text layout displayed by the application 106 and a logical layout which is the text layout stored in a buffer or internal memory storage of the application 106. While the selection may appear continuous to the user 104 based on the visual layout, the selection may be broken based on the logical layout. For example, if the user 104 makes a selection that spans the boundary and includes a portion of the right-to-left text and a portion of the left-to-right text, but the user 104 does not understand the distinction between text directionality of the two portions, the user 103 may expect that the some characters towards the end of the portion of left-to-right text, and some characters towards the start of the right-to-left text have been selected. However, the actual selection includes characters towards the end of the right-to-left text. Therefore, the text editing module 118 may retrieve the logical layout of the bi-directional text from a buffer or internal memory storage of the application 106. The right-to-left text and the left-to-right text of the bi-directional text may be stored similarly in the buffer with increasing indices. The buffer may be stored locally at a local storage 108 of the device 102 or remotely at a remote data store managed by the storages servers 120 of the productivity service 114.

Based on the retrieved layout, the text editing module 118 may determine an amount of additional text to be selected within the document in order to make the selection logically continuous. The text editing module 118 may then provide a visual indicator to be displayed through a user interface of the application 106, where the visual indicator identifies the additional text to be selected within the document in order to make the selection logically continuous. The visual indicator may include a textual scheme, a graphical scheme, a formatting scheme, an animation scheme, a coloring scheme, a highlighting scheme, and/or a shading scheme. The scheme employed for the visual indicator may also be distinct from a scheme employed to indicate the selection within the document so that the visual indicator is obvious to the user 104. Additionally, one of a dialog box notification and a toolbar notification may be provided through the user interface of the application 106 to alert the user 104 that the selection is logically broken. The notification may include an option to automatically select the additional text identified in order to make the selection continuous.

In another example, two or snore users may be co-authoring the document being processed by the application 106. If at least one of the users' selection is the selection determined to be logically broken, the text editing module 118 may provide the visual indicator to be displayed through a user interface of the application 106 such that each of the two or more users are enabled to view and interact with the visual indicator. Additionally, the text editing module 118 may provide a notification to alert each of the two or more users that the selection is logically broken for display through the user experience of the application 106. The notification may include an option to automatically select the additional text identified in order to make the selection continuous.

As previously discussed, when working with bi-directional text within a document it may be possible for a user to select a portion of the text which visually appears continuous, but is logically broken. When a user selects and subsequently performs operations on the logically broken text such as a formatting change or a cut and paste, the result may not always be as desired. Therefore, embodiments are directed to provide visual feedback to the user to help them identify that the selection is logically broken, as well as to help them modify the selection such that the visual & logical text selection are the same (that is, modify the selection such that selection is both visually and logically continuous). Provision of the visual indicator employing various and distinct schemes, along with the additional provision of notifications to alert the user of the broken selection, may improve usability and increase user interactivity. Additionally, provision of the option to automatically select the additional text identified in order to make the selection continuous may reduce manual steps that would need to be taken by the user in order to correct the broken selection further improving usability.

In further embodiments, visual feedback for a broken text selection of vertical, bi-directional text may be provided in a similar manner as described above for horizontal, bi-directional text. For example, the bi-directional text may include top-to-bottom text and bottom-to-top text that meet at a boundary. The user 104 may make a selection within the document. If the selection spans the boundary such that the selection includes a portion of the top-to-bottom text and a portion of the bottom-to-top text, the text editing module 118 may determine that the selection is logically broken. The test editing module 118 may then determine an amount of additional text to be selected within the document in order to make the selection logically continuous, and provide a visual indicator to be displayed through a user interface of the application 106 to identify the additional text to be selected within the document in order to make the selection logically continuous.

Embodiments, as described herein, address a need that arises from very large scale of operations created by software-based services that cannot be managed by humans. The actions/operations described herein are not a mere use of a computer, but address results of a system that is a direct consequence of software used as a service offered in conjunction with creation, editing, and/or sharing of content that contains bi-directional text.

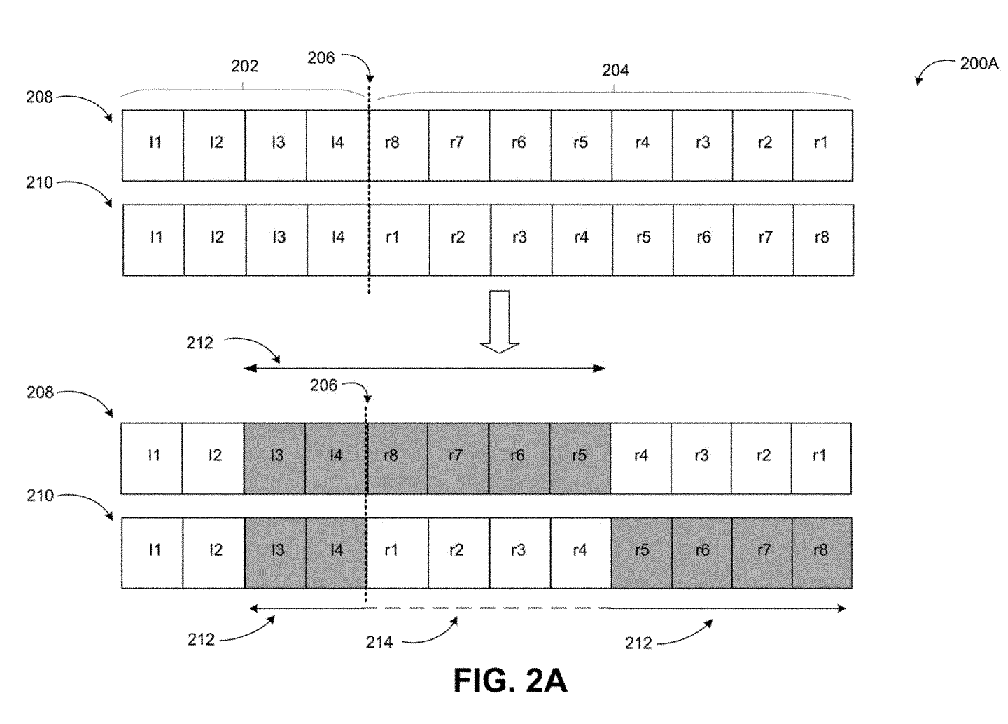

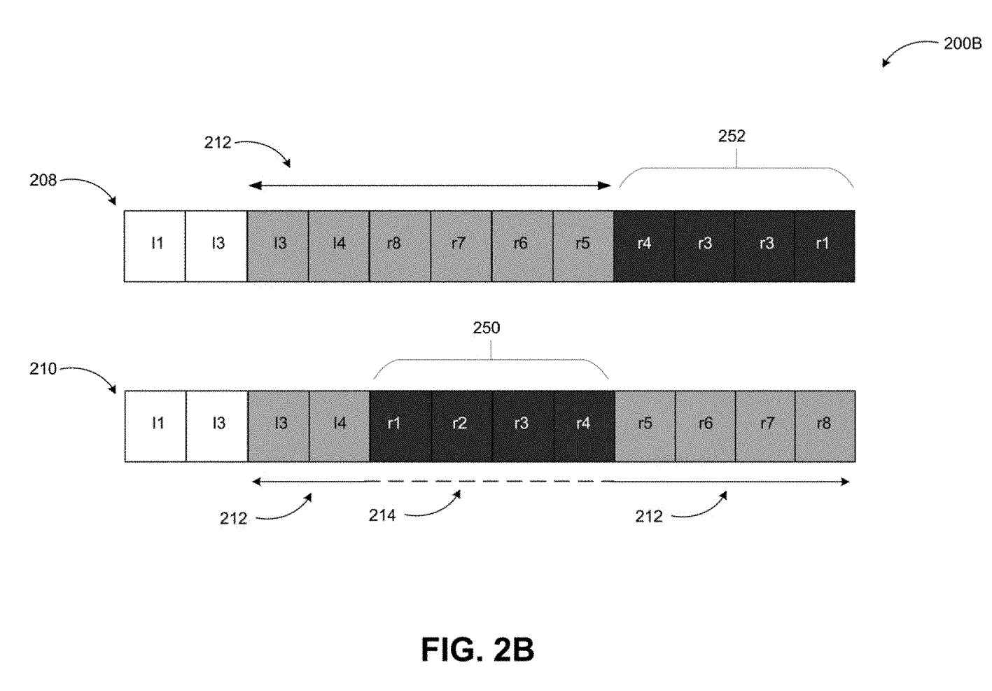

FIGS. 2A-B include display diagrams illustrating an example of a broken text selection and provision of visual feedback in response to the broken text selection. As shown in a diagram 200A of FIG. 2A, a document that is being processed by an application may include horizontal or vertical bi-directional text. The application may be a word-processing application, a presentation application, a spreadsheet application, a notebook application, and/or a communication application, for example, associated with a productivity service configured to enable users to create, edit, and/or share content among multiple devices and across a variety of platform. The bi-directional text may be horizontal text that includes right-to-left text 204 and left-to-right text 202 that meet at a boundary 206.

There may be two types of text layouts, a visual layout 208 and a logical layout 210. The visual layout 208 may be a text layout shown by the application and a logical layout 210 may be the text layout stored in a buffer or internal memory storage of the application. A user may make a selection 212 within the document. The selection 212 may span the boundary 206 such that the selection 212 includes a portion of the right-to-left text 204 (for example, 13 and 14) and a portion of the left-to-right text 202 (for example, r8, r7, r6, and r5). Although the selection 212 may appear continuous to the user based on the visual layout 208, the selection 212 may be broken 214 based on the logical layout 210. In response to a determination that the selection 212 is broken 214, an amount of additional text 250 to be selected within the document in order to make the selection logically continuous may be determined based on the logical layout 210.

As shown in a diagram 200B in FIG. 2B, a visual indicator 252 may then be displayed in the visual layout 208 through a user interface of the application, where the visual indicator 252 identifies the additional text to be selected within the document in order to make the selection 212 logically continuous. The visual indicator 252 may be displayed employing a shading scheme, as illustrated. In other embodiments, the visual indicator 252 may be displayed employing a textual scheme, a graphical scheme, a formatting scheme, an animation scheme, a coloring scheme, and or a highlighting scheme, among other examples. The scheme employed for the visual indicator 252 may also be distinct from a scheme employed to indicate the selection 212 within the document that the visual indicator 252 is obvious to the user.

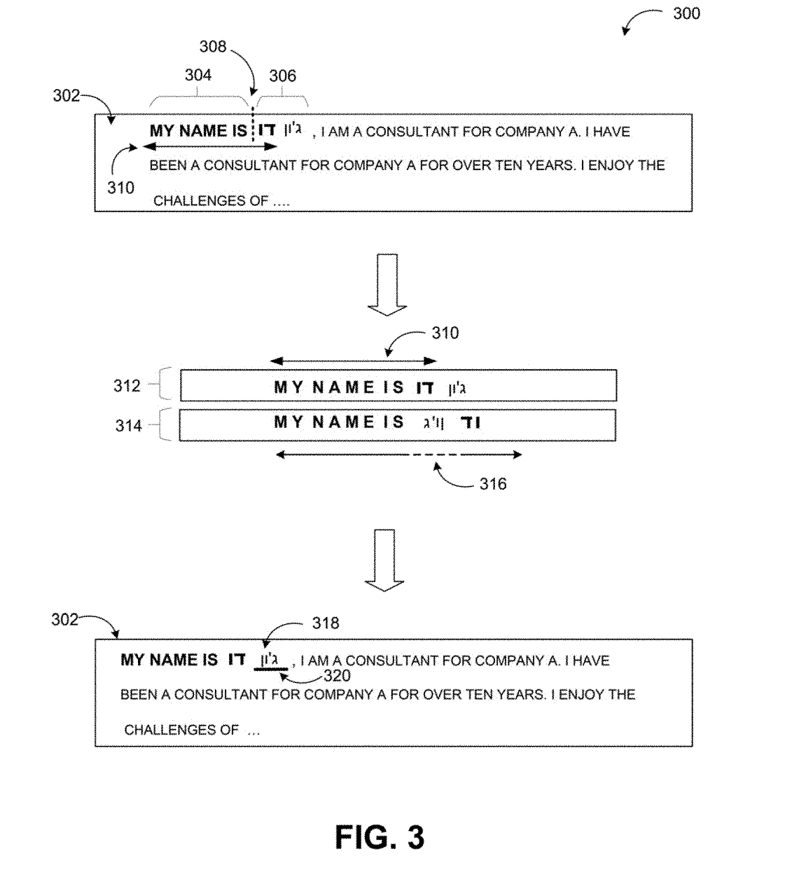

FIG. 3 includes a display diagram illustrating another example of a broken text selection and provision of visual feedback in response to the broken text selection.

As shown in a diagram 300, a document that being, processed by an application may be disponed through a user interface 302 of the application. The document may include bi-directional text, where the bi-directional text may include right-to-left text 306 and left-to-right text 304 that meet at a boundary 308. For example, the right-to-left text 306 may include characters from the Hebrew alphabet, and the left-to-right text 304 may include characters from the English alphabet. A user may make a selection 310 within the document. For example, the user may wish to select a portion of text from the document to copy and paste. Here the selection 310 is illustrated with bold, enlarged text. The selection may span the boundary 308 such that the selection includes a portion of the right-to-left text 306 (for example, “ [symbol] ”) and a portion of the left-to-right text 304 (for example, “My name is”).

There may be two types of text layouts, a visual layout 312 and a logical layout 314. The visual layout 312 may be a text layout displayed by the user interface 302 of the application and a logical layout 314 may be the text layout stored in a buffer or internal memory storage of the application. Although the selection 310 may appear continuous to the user based on the visual layout 312, the selection may be broken 316 based on the logical layout 314. If left broken, operations performed on the broken selection, such as the copy and paste operation, may lead to the pasting of a discontinuous string, which may not produce meaningful results. For example, for a user who docs not understand Hebrew and its right-to-left directionality, the expectation is that the initial characters of the English text, and some characters towards the start of the Hebrew text, such a first name, have been selected. However, the actual selection includes characters towards the end of the Hebrew text, such as a last name.

Therefore, in response to a determination that the selection is broken 316, an amount of additional text 318 to be selected within the document in order to make the selection logically continuous may be determined based on the logical layout 314. A visual indicator 320 may then be displayed through the user interlace 302 of the application, where the visual indicator 320 identifies the additional text 318 to be selected within the document in order to make the selection logically continuous. The visual indicator 320 may be displayed employing a formatting scheme, such as underlining, as illustrated. In other embodiments, the visual indicator 320 may be displayed employing a textual scheme, a graphical scheme, a shading scheme, an animation scheme, a coloring scheme, and or a highlighting scheme, among other examples. The scheme employed for the visual indicator 320 may also be distinct from a scheme employed to indicate the selection 310 within the document so that the usual indicator 320 is obvious to the user,

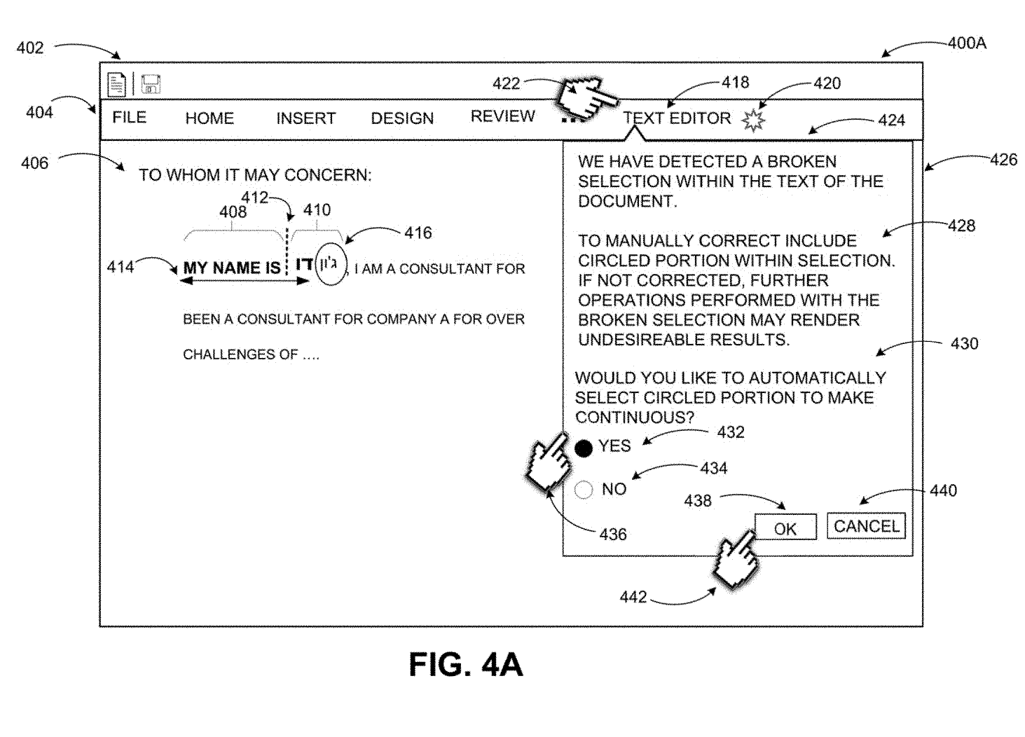

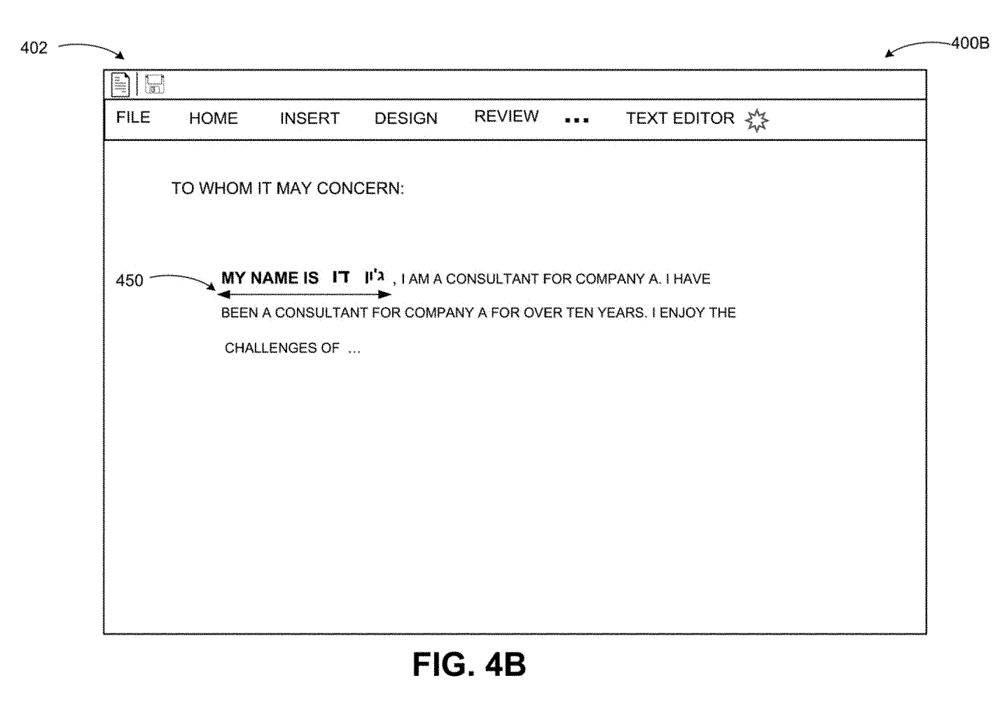

FIGS. 4A-B include display diagrams illustrating an example user experience configuration for provision of visual feedback in response to a broken text selection. As shown in a diagram 400A of FIG. 4A and 400B of FIG. 4B, a user may open a document 406 through an application executing on a computing device of the user, where the document may be displayed through a user experience 402 of the application. The user experience 402 may include a tool bar 404 comprising one or more tabs, where one of the tabs may be a text editor tab 418, for example. The document 406 may be a word-processing document, for example.

A text editing module integrated with and/or configured to serve the application associated with the productivity service may detect vertical or horizontal bi-directional text within the document 406. The bi-directional text may be horizontal text that includes right-to-left text 410, such as characters from the Hebrew alphabet, and left-to-right text 408, such as characters from the English alphabet, that meet at a boundary 412. A user may make a selection 414 within the document 406. Here the selection 414 is illustrated with bold, enlarged text. The selection 414 may span the boundary 412 such that the selection includes a portion of the right-to-left text 410 (for example, “ [symbol] ”) and a portion of the left-to-right text 408 (for example, “My name is”).

In response to the selection 414, the text editing module may determine that the selection 414 is logically broken. For example, there may be two types of text layouts, a visual layout displayed by the user experience 402 of the application and a logical layout stored in a buffer or internal memory storage of the application. Although the selection 414 may appear continuous to the user based on the visual layout, the selection may be broken based on the logical layout. If left broken, operations performed on the broken selection 414 may lead to undesirable results. Therefore, in response to a determination that the selection 414 is broken, an amount of additional text to be selected within the document in order to make the selection logically continuous may be determined bused on the logical layout, which may be retrieved from the buffer of the application. A visual indicator 416 may then be displayed through the user experience 402 of the application, where the visual indicator 416 identifies the additional text to be selected within the document in order to make the selection logically continuous. The visual indicator 416 may be displayed employing a formatting scheme, such as circling, as illustrated. In other embodiments the visual indicator 416 may be displayed employing a textual scheme, a graphical scheme, a shading scheme, an animation scheme, a coloring scheme, and/or a highlighting scheme, among other examples. The scheme employed for the visual indicator 416 may also be distinct from a scheme employed to indicate the selection 414 within the document.

In addition to the visual indicator 416, a notification 424 may be provided for display through the user experience 402 in conjunction with the text editor tab 418 of the tool bar 404 to alert the user of the logically broken selection. The notification 424 may include a graphical icon 420, such as a star, adjacent to the text editor tab 418 that alerts the user to a new notification, as illustrated. In some examples, the graphical icon 420 may be animated to further draw the user's attention. In response to a user selection 422 of the graphical icon 420 and/or the text editor tab 418, the notification 424 may be displayed. The notification 424 may include an action detected 426, a prompt 428, a main instruction 430, and one or more selections 432, 434 in response to the main instruction 430. The action detected 426 may be the selection of logically broken text within the document. The prompt 428 may indicate manual actions that the user may take to correct the logically broken selection using the visual indicator 416 as a guide. For example, the user may correct the broken text selection by including the circled portion within the selection. The prompt 428 may also indicate consequences of not correcting the logically broken text selection. For example, any further operations performed on the broken text selection may produce undesirable results. The main instruction 430 may include an option to automatically select the additional text in order to make the selection logically continuous, where the responses to the main instruction 430 include either a “yes” 432 or “no” 434. If the user selects “no” 434 in response to the main instruction 430 followed by a selection of an “OK” command 438, or the user selects a “Cancel” command 440, the text editing module may make no changes to the selection. Therefore, the user must either manually correct the broken text selection and/or risk undesirable results when operations are performed on the broken text selection. However, as illustrated, a first user selection 436 of “yes” 432 in response to the main instruction 430, followed by a second user selection 442 of an “OK” command 438 may cause the text editing module to automatically select the additional text (indicated by the visual indicator 416) in order to make the selection logically continuous, as shown in selection 450 in diagram 400B of FIG. 4B. The continuous selection 450 may be displayed through the user experience 402 of the application employing a same scheme used for the initial selection 414.

Embodiments are not limited to the configuration of the notification 424 as illustrated in FIG. 4A. The notification 424 may be displayed using a textual scheme, a graphical scheme, an audio scheme, an animation scheme, a coloring scheme, a highlighting scheme, and/or a shading scheme to enhance the display within the user experience 402, for example.

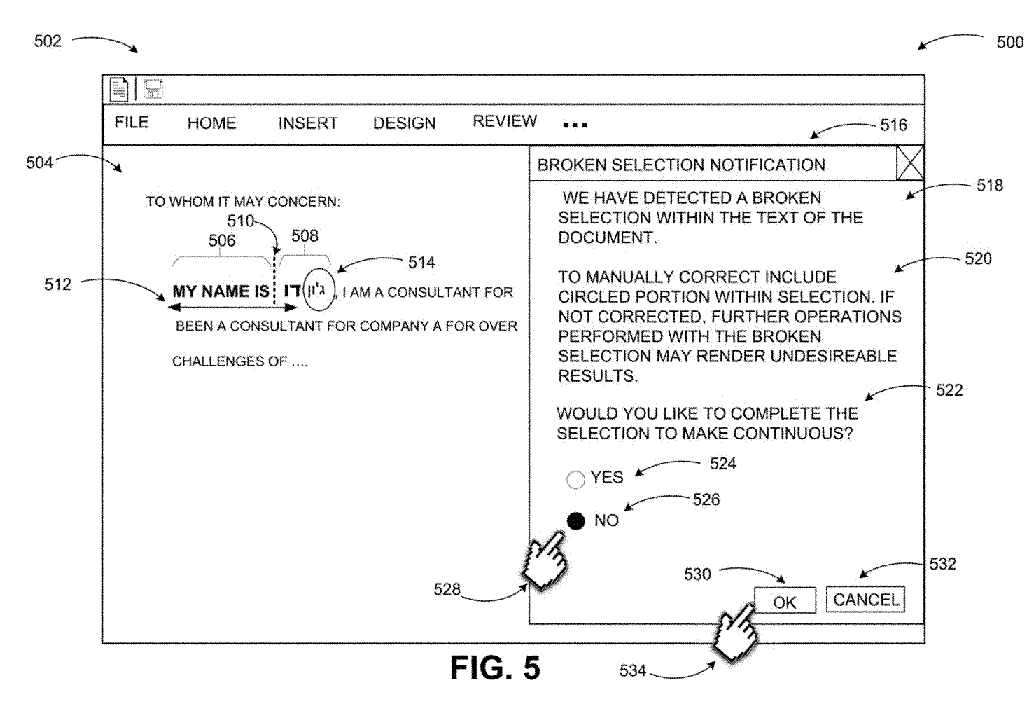

FIG. 5 includes a display diagram illustrating another example user experience configuration for provision of visual feedback in response to a broken text selection. As shown in a diagram 500, a user may open a document 504 through an application executing on a computing device of the user, where the document may be displaced through a user experience 502 of the application. The document 504 may be a word-processing document, for example.

A text editing module integrated with and and/or configured to serve the application associated with the productivity service may detect vertical or horizontal bi-directional text within the document 504. The bi-directional text may be horizontal text that includes right-to-left text 508, such as characters from the Hebrew alphabet, and left-to-right text 506, such as characters from the English alphabet, that meet at a boundary 510. A user may make a selection 512 within the document 504. Here the selection 512 is illustrated with bold, enlarged text. The selection 512 may span the boundary 510 such that the selection includes a portion of the right-to-left text 508 (for example, “ [symbol] ”) and a portion of the left-to-right text 506 (for example, “My name is”).

In response to the selection 512, the text editing module may determine that the selection 512 is logically broken. For example, there ma be two types of text layouts, a visual layout displayed by the user experience 502 of the application and a logical layout stored in a buffer or internal memory storage of the application. Although the selection 512 may appear continuous to the user based on the visual layout, the selection may be broken based on the logical layout. If left broken, operations performed on the broken selection 512 may lead to undesirable results. Therefore, in response to a determination that the selection 512 is broken, an amount of additional text to be selected within the document in order to make the selection logically continuous may be determined based on the logical layout, which may be retrieved from the buffer of the application.

A visual indicator 514 may then be displayed through the user experience 502 of the application, where the visual indicator 514 identifies the additional text to be selected within the document in order to make the selection logically continuous. The visual indicator 514 may be displayed employing a formatting scheme, such as circling, as illustrated. In other embodiments, the visual indicator 514 may be displayed employing a textual scheme, a graphical scheme, a shading scheme, an animation scheme, a coloring scheme, and/or a highlighting scheme, among other examples. The scheme employed for the visual indicator 514 may also be distinct from a scheme employed to indicate the selection 512 within the document

In addition to the visual indication 514, a notification 516 may be provided for display through the user experience 502 of the application to alert the user of the logically broken selection. The notification 516 may be a dialog box notification, as illustrated, that includes an action detected 518, a prompt 520, a main instruction 522, and one or more selections 524, 526 in response to the main instruction 522. The action detected 518 may be the selection of logically broken text within the document. The prompt 520 may indicate manual actions that the user may take to correct the logically broken selection using the visual indicator 514 as a guide. For example, the user may correct the broken text selection by including the circled portion within the selection. The prompt 520 may also indicate consequences of not correcting the logically broken text selection. For example, any further operations performed on the broken text selection may produce undesirable results. The main instruction 512 may include an option to automatically select the additional text to be selected within the document in order to make the selection logically continuous, where the responses to the main instruction 522 include either a “yes” 524 or “no” 526. A user selection 528 of “not” 526 in response to the main instruction 523, followed by a second user selection 534 of an “OK” command 530 may cause no changes to the selection. The user must either manually correct the broken text selection and/or risk undesirable results when operations are performed on the broken text. Alternatively, the user may select a “Cancel” command 532 if the user does not wish to automatically select the additional text to be selected within the document in order to make the selection logically continuous. Similarly, the user must either manually correct the broken text selection and/or risk undesirable results when operations are performed on the broken text.

Embodiments are not limited to the configuration of the notification 516 as illustrated in FIG. 5. The notification 516 may be displayed using a textual scheme, a graphical scheme, an audio scheme, an animation scheme, a coloring scheme, a highlighting scheme, and/or a shading scheme to enhance the display within the user experience 502, for example.

The examples provided in FIGS. 1A-C through 5 are illustrated with specific systems, services, applications, modules, and user experiences. Embodiments are not limited to environments according to these examples. Provision of visual feedback for broken text selection may be implemented in environments employing fewer or additional systems, services, applications, modules, and user experiences. Furthermore, the example systems, services, applications, modules, and user experiences shown in FIGS. 1A-C through 5 may be implemented in a similar manner with other values using the principles described herein.

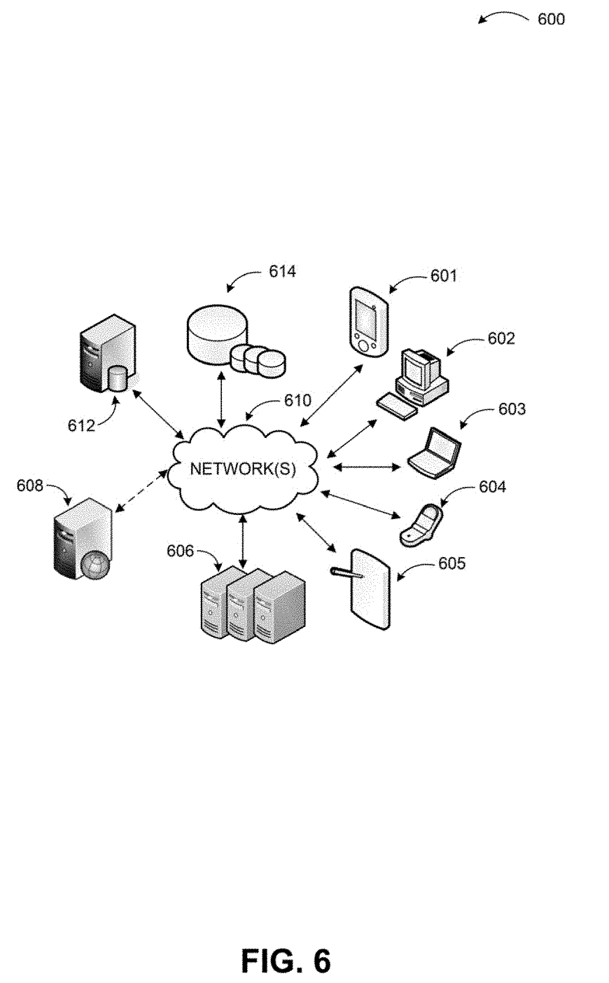

FIG. 6 is a networked environment, where a system according to embodiments may be implemented. In addition to locally installed applications (for example, application 106), a text editing module may also be employed in conjunction with hosted applications and services (for example, a productivity service 114) that may be implemented via software executed over one or more servers 606 or individual server 608, as illustrated in diagram 600. A hosted service or application may communicate with client applications on individual computing devices such as a handheld computer 601, a desktop computer 602. a laptop computer 603, a smart phone 604, a tablet computer (or slate), 605 (‘client devices’) through network(s) 610 and control a user interface presented to users.

Client devices 601-605 are used to access the functionality provided by the hosted service or application. One or more of the servers 606 or server 608 may be used to provide a variety of services as discussed above. Relevant data may be stored in one or more data stores (e.g. data store 614), which may be managed by any one of the servers 606 or by database server 612.

Network(s) 610 may comprise any topology of servers, clients, Internet service providers, and communication media. A system according to embodiments may have a static or dynamic topology. Network(s) 610 may include a secure network such as an enterprise network, an unsecure network such as a wireless open network, or the Internet. Network(s) 610 may also coordinate communication over other networks such as PSTN or cellular networks. Network(s) 610 provides communication between the nodes described herein. By way of example, and not limitation, network(s) 610 may include wireless media such as acoustic, RF, infrared and other wireless media.

Many other configurations of computing devices, applications, engines, and modules may be employed to provide visual feedback for broken text selection. Furthermore, the networked environments discussed in FIG. 6 are for illustration purposes only. Embodiments are not limited to the example services, applications, engines, modules or processes.

FIG. 1 is a block diagram of an example general purpose computing device, which may be used to rank query results for relevance based on external context.

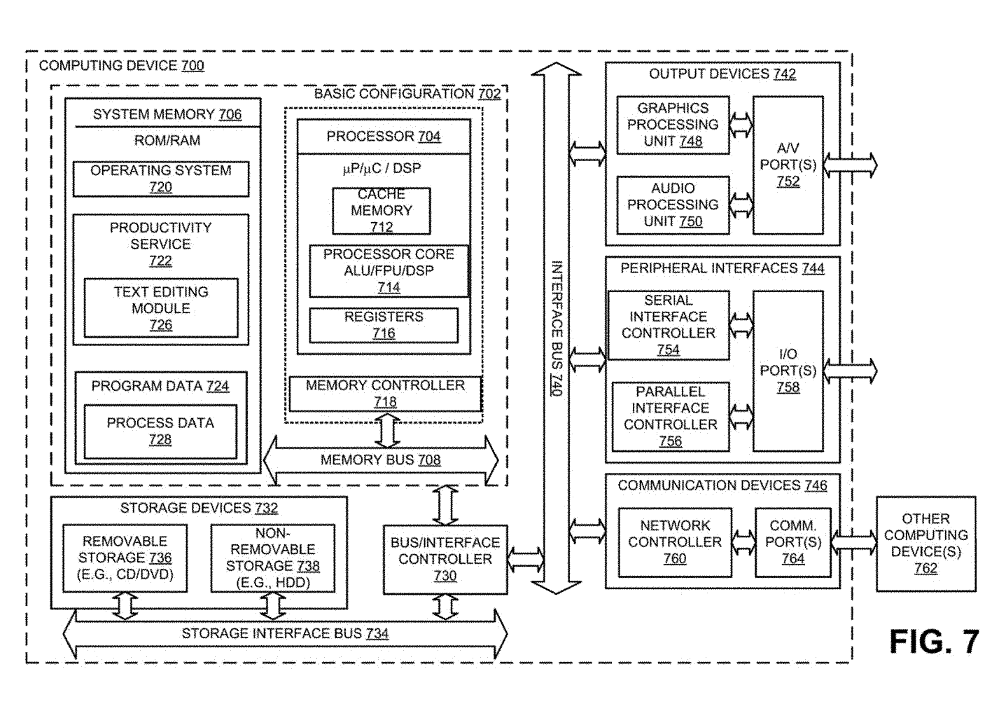

For example, computing device 700 may be used as a server, desktop computer, portable computer, smart phone, special purpose computer, or similar device. In an example basic configuration 702, the computing device 700 may include one or more processors 704 and a system memory 706. A memory bus 708 may be used for communicating between the processor 704 and the system memory 706. The basic configuration 702 is illustrated in FIG. 7 by those components within the inner dashed line.

Depending on the desired configuration, the processor 704 may be of any type, including but not limited to a microprocessor (μP), a microcontroller (μC), a digital signal processor (DSP), or any combination thereof. The processor 704 may include one more levels of caching, such as a level cache memory 712, one or more processor cores 714, and registers 716. The example processor cores 714 may (each) include an arithmetic logic unit (ALU), a floating point unit (FPU), a digital signal processing core (DSP Core), or any combination thereof. An example memory controller 718 may also be used with the processor 704, or in some implementations the memory controller 718 may be an internal part of the processor 704.

Depending on the desired configuration, the system memory 706 may be of any type including but not limited to volatile memory (such as RAM), non-volatile memory (such as ROM, flash memory, etc.) or any combination thereof. The system memory 706 may include an operating system 720, a productivity service 722, and program data 724. The productivity service 722 may include a text editing module 726, which may be an integrated module of the productivity service 722. In other embodiments, the editing module 726 may be an integrated module of a locally installed application of the productivity service or the editing module 726 may be a separate module associated with a third party service configured to serve multiple applications of the productivity service 722. The text editing module 722 may be configured to detect bi-directional text within a document, where the bi-directional text includes right-to-left text and left-to-right text that meet at a boundary. In response to a selection within the document that spans the boundary such that the selection includes a portion of the right-to-left test and a portion of the left-to-right text, the text editing module 722 may be configured to determine the selection is logically broken. The text editing module 722 may then be configured to determine an amount of additional text to be selected within the document in order to make the selection logically continuous, and provide to be displayed a visual indicator to identify the additional text to be selected within the document in order to make the selection logically continuous based on the determination. The program data 724 may include, among other data, process data 728 such as visual and/or logical text layouts, as described herein.

The computing device 700 may have additional features or functionality, and additional interfaces to facilitate communications between the basic configuration 702 and any desired devices and interfaces, for example, a bus/interface controller 730 may be used to facilitate communications between the basic configuration 702 and one or more data storage devices 732 via a storage interface bus 734. The data storage devices 732 may be one or more removable storage devices 736, one or more non-removable storage devices 738, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 706, the removable storage devices 730 and the non-removable storage devices 738 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 700. Any such computer storage media may be part of the computing device 700.

The computing device 700 may also include an interlace bus 740 for facilitating communication from various interface devices (for example, one or more output devices 742, one or more peripheral interfaces 744, and one or more communication devices 746) to the basic configuration 702 via the bus/interface controller 730. Some of the example output devices 742 include a graphics processing unit 748 and an audio processing unit 750, which may be configured to communicate to various external devices such as a display or speakers via one or more AV ports 752. One or more example peripheral interlaces 744 may include a serial interface controller 754 or a parallel interface controller 756, which may be configured to communicate with external devices such as input devices (for example, keyboard, mouse, pen, voice input device, touch input device, etc.) or other peripheral devices (for example, printer, scanner, etc.) via one or more I/O ports 758. An example communication device 746 includes a network controller 760, which may be arranged to facilitate communications with one or more other computing devices 762 over a network communication link via one or more communication ports 764. The one or more other computing devices 702 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any Information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 700 may be implemented as a part of a general purpose or specialized server, mainframe, or similar computer that includes any of the above functions. The computing device 700 may also be implemented as a personal computer including both laptop computer and non-laptop computer configurations.

Example embodiments may also include methods to provide visual feedback for broken text selection. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

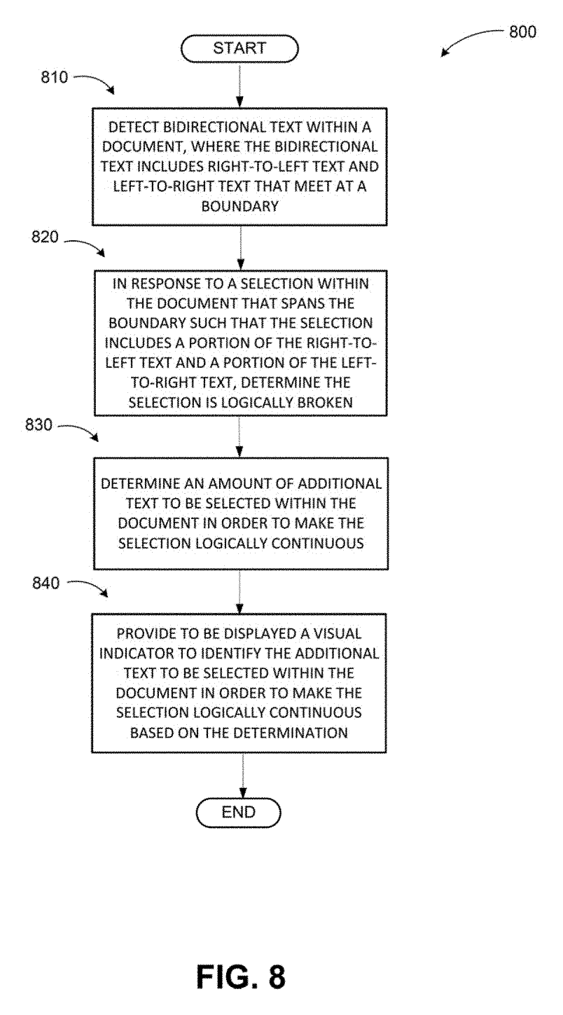

FIG. 8 illustrates a logic flow diagram of a method to provide visual feedback for broken text selection. Process 800 may be implemented on a computing device, server, or other system. An example system may include a server comprising a communication interface configured to facilitate communication between a productivity service and a device executing an application hosted by the productivity service, a memory configured to store instructions, and one or more processors coupled to the memory and the communication interface and configured to execute a text editing module. The text editing module may be configured to provide visual feedback for broken text selection.

Process 800 begins with operation 810, where the text editing module may be configured to detect bi-directional text within a document. The bi-directional text may be horizontal text that includes right-to-left text and left-to-right text that meet at a boundary. In other examples, the bi-directional text may be vertical text that includes top-to-bottom text and bottom-to-top text that meet at a boundary. For example, the bi-directional text may include one or more different types of alphabets and/or boustrophedon.

At operation 830, in response to a selection within the document that spans the boundary such that the selection includes a portion of the right-to-left text and a portion of the left-to-right text, the text editing module may be configured to determine the selection is logically broken. For example, there may be two types of text layouts, a visual layout displayed through a user interface of the application and a logical layout stored in a buffer or internal memory storage of the application. While the selection may appear continuous based on the visual layout, the selection may be broken based on the logical layout. For example, a user who does not understand the distinction between text directionality of the two portions3 may expect that the some characters towards the end of the portion of left-to-right text, and some characters towards the start of the right-to-left text have been selected. However, the actual selection includes characters towards the end of the right-to-left text.

At operation 830, the text editing module may be configured to determine an amount of additional text to be selected within the document in order to make the selection logically continuous. The text editing module may retrieve a layout of the bi-directional text from a buffer of the application in order to determine the amount of additional text to be selected.

At operation 840, the text editing module may be configured to provide to be displayed a visual indicator to identity the additional text to be selected within the document in order to make the selection logically continuous based on the determination. A textual scheme, a graphical scheme, a formatting scheme, an animation scheme, a coloring scheme, a highlighting scheme, and/or a shading scheme may be employed to display the visual indicator. Additionally the scheme employed to display the visual indicator may be distinct from a scheme employed to indicate the selection within the document. In some embodiments, a notification may also be provided for display to alert a user that the selection is logically broken, where the notification may include an option to automatically select the additional text.

The operations included in process 800 are for illustration purposes. Provision of visual feedback for broken text selection may be implemented by similar processes with fewer or additional steps, as well as in different order of operations using the principles described herein. flic operations described herein may be executed by one or more processors operated on one or more computing devices, one or more processor cores, specialized processing devices, and/or general purpose processors, among other examples.

According to some embodiments, means to provide visual feedback for broken text selection are provided. Example means include detecting bi-directional text within a document, where the bi-directional text may include right-to-left text and left-to-right text that meet at a boundary, and in response to a selection within the document that spans the boundary such that the selection includes a portion of the right-to-left text and a portion of the left-to-right text, determining the selection is logically broken. Example means may also include determining an amount of additional text to be selected within the document in order to make the selection logically continuous, and providing to be displayed a visual indicator to identify the additional text to be selected within the document in order to make the selection logically continuous based on the determination.

According to some examples, methods to provide visual feedback for broken text selection are provided. An example method includes detecting bi-directional text within a document, where the bi-directional text may include right-to-left text and left-to-right text that meet at a boundary, and in response to a selection within the document that spans the boundary such that the selection includes a portion of the right-to-left text and a portion of the left-to-right text, determining the selection is logically broken. The example method may also include determining an amount of additional text to be selected within the document in order to make the selection logically continuous, and providing to be displayed a visual indicator to identify the additional text to be selected within the document in order to make the selection logically continuous based on the determination.

In other examples, a notification may be provided to be displayed to alert a user that the selection is logically broken through a user experience of an application processing the document. The notification may be configured as a dialog box notification or a toolbar notification. An option may be provided within the notification to automatically select the additional text identified in order to make the selection continuous. At least one of a textual scheme, a graphical scheme, a formatting scheme, an animation scheme, a coloring scheme, a highlighting scheme, and/or a shading scheme may be employed to display the visual indicator.

In further examples, a layout of the bi-directional text may be retrieved from a buffer of an application processing the document. The right-to-left text and the left-to-right text of the bi-directional text may be stored similarly in the buffer with increasing indices. In response to a determination that two or more users are co-authoring the document and at least one of the users' selection is the selection determined to be logically broken, the visual indicator may be provided to be displayed such that each of the two or more users are enabled to view and interact with the visual indicator. A notification to alert each of the two or more users that the selection is logically broken may also be provided to be displayed through a user experience of an application processing the document; where the notification may include an option to automatically select the additional text identified in order to make the selection continuous.

According to some embodiments, servers configured to provide visual feedback for broken text selection may be described. An example server may include a communication interface configured to facilitate communication between a productivity service and a device executing an application hosted by the productivity service, a memory configured to store instructions, and one or more processors coupled to the memory and configured to execute a text editing module. The text editing module may be configured to detect bi-directional text within a document executed by the application, where the bi-directional text includes right-to-left text and left-to-right text that meet at a boundary, and in response to a selection within the document that spans the boundary such that the selection includes a portion of the right-to-left text and a portion of the left-to-right text, determine the selection is logically broken. The text editing module may also be configured to determine an amount of additional text to be selected within the document in order to make the selection logically continuous, and provide to be displayed a visual indicator to identity the additional text to be selected within the document in order to make the selection logically continuous based on the determination.

In other embodiments, a layout of the bi-directional text may be retrieved from a buffer of the application in order to determine the amount of additional text to be selected within the document, where the buffer of the application may be stored locally at a local data store of the device or remotely at a remote data store of the productivity service. A notification to alert a user that the selection is logically broken may be provided to be displayed through a user experience of the application, where the notification may be configured as a dialog box notification or a toolbar notification. An option may be provided within the notification to automatically select the additional text identified in order to make the selection continuous.

In further embodiments, the text editing module may be an integral module of the productivity service. The text editing module may be an integral module of the application locally installed on the device. The text editing module may be a separate module associated with a third party service configured to serve multiple applications hosted by the productivity service. The application may be a word-processing application, a presentation application, a notebook application, a communication application, or a spreadsheet application.

According to some examples, methods to provide visual feedback for broken text selection are provided. An example method includes detecting bi-directional text within a document, where the bi-directional text may include right-to-left text and left-to-right text that meet at a boundary, and in response to a selection of text within the document that spans the boundary such that the selection includes a portion of the right-to-left text and a portion of the left-to-right text, determining the selection is logically broken, and determining an amount of additional text to be selected within the document in order to make the selection logically continuous. The example method may also include providing to be displayed a visual indicator to identify the additional text to be selected within the document in order to make the selection logically continuous based on the determination, and providing to be displayed a notification that the selection is logically broken, where the notification may include an option to automatically select the additional text identified in order to make the selection continuous.

In other examples, the bi-directional text may include one or more different types of alphabets and boustrophedon. A scheme employed to display the visual indicator may be distinct from a scheme employed to indicate the selection within the document, where the scheme may include a textual scheme, a graphical scheme, a formatting scheme, an animation scheme, a coloring scheme, a highlighting scheme, and/or a shading scheme.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to provide visual feedback for broken text selection, the method comprising:
detecting bi-directional text within a document, wherein the bi-directional text includes right-to-left text and left-to-right text that meet at a boundary;
in response to a selection within the document that spans the boundary such that the selection includes a portion of the right-to-left text and a portion of the left-to-right text, determining the selection is logically broken;
determining an amount of additional text to be selected within the document in order to make the selection logically continuous; and
providing to be displayed a visual indicator to identify the additional text to be selected within the document in order to make the selection logically continuous based on the determination.

2. The method of claim 1, further comprising:
providing to be displayed a notification to alert a user that the selection is logically broken through a user experience of an application processing the document.

3. The method of claim 2, further comprising:
configuring the notification as one of a dialog box notification and a toolbar notification.

4. The method of claim 2, further comprising:
providing an option within the notification to automatically select the additional text identified in order to make the selection continuous.

5. The method of claim 1, wherein providing to be displayed the visual indicator to identify the additional text to be selected within the document in order to make the selection logically continuous comprises:
employing at least one from a set of: a textual scheme, a graphical scheme, a formatting scheme, an animation scheme, a coloring scheme, a highlighting scheme, and a shading scheme to display the visual indicator.

6. The method of claim 1, wherein determining the amount of additional text to be selected within the document in order to make the selection logically continuous comprises:
retrieving a layout of the bi-directional text from a butler of an application processing the document.

7. The method of claim 6, wherein the right-to-left text and the left-to-right text of the bi-directional text are stored similarly in the buffer with increasing indices.

8. The method of claim 1, further comprising:
in response to a determination that two or more users are co-authoring the document and at least one of the users' selection is the selection determined to be logically broken, providing to be displayed the visual indicator such that each of the two or more users are enabled to view and interact with the visual indicator.

9. The method of claim 8, further comprising:
providing to be displayed a notification to alert each of the two or more users that the selection is logically broken through a user experience of an application processing the document; wherein the notification may include an option to automatically select the additional text identified in order to make the selection continuous.

10. A server configured to provide visual feedback tor broken text selection, the server comprising:
a communication interlace configured to facilitate communication between a productivity service and a device executing an application hosted by the productivity service;
a memory configured to store instructions; and
one or more processors coupled to the memory and configured to execute a text editing module, wherein the text editing module is configured to:
detect bi-directional text, within a document executed by the application, wherein the bi-directional text includes right-to-left text and left-to-right text that meet at a boundary;
in response to a selection within the document that spans the boundary such that the selection includes a portion of the right-to-left text and a portion of the left-to-right text, determine the selection is logically broken;
determine an amount of additional text to be selected within the document in order to make the selection logically continuous; and
provide to be displayed a visual indicator to identify the additional text to be selected within the document in order to make the selection logically continuous based on the determination.

11. The server of claim 10, wherein the text editing module is further configured to:
retrieve a layout of the bi-directional text from a buffer of the application in order to determine the amount of additional text to be selected within the document, wherein the butler of the application is stored locally at a local data store of the device or remotely at a remote data store of the productivity service.

12. The server of claim 10, wherein the text editing module is further configured to:
provide to be displayed a notification to alert a user that the selection is logically broken through a user experience of the application, wherein the notification is configured as one of a dialog box notification and a toolbar notification.

13. The server of claim 12, wherein the text editing module is further configured to:
provide an option within the notification to automatically select the additional test identified in order to make the selection continuous.

14. The server of claim 10, wherein the text editing module is an integral module of the productivity service.

15. The server of claim 10, wherein the text editing module is an integral module of the application locally installed on the device.

16. The server of claim 10, wherein the text editing module is a separate module associated with a third party service configured to serve multiple applications hosted by the productivity service.

17. The server of claim 10, wherein the application is one of a word-processing application, a presentation application, a notebook application, a communication application, and a spreadsheet application.

18. A method to provide visual feedback for broken text selection, the method comprising:
detecting bi-directional text within a document, wherein the bi-directional text includes right-to-left text and left-to-right text that meet at a boundary;
in response to a selection of text within the document that spans the boundary such that the selection includes a portion of the right-to-left text and a portion of the left-to-right text, determining the selection is logically broken;
determining an amount of additional text to be selected within the document in order to make the selection logically continuous;
providing to be displayed a visual indicator to identity the additional text to be selected within the document in order to make the selection logically continuous based on the determination; and
providing to be displayed a notification that the selection is logically broken, wherein the notification includes an option to automatically select the additional text identified in order to make the selection continuous.

19. The method of claim 18, wherein the bi-directional text includes one or more different types of alphabets and boustrophedon.

20. The method of claim 18, wherein providing to be displayed the visual indicator further comprises:
employing a scheme to display the visual indicator that is distinct from a scheme employed to indicate the selection within the document, wherein the scheme includes one or more of a textual scheme, a graphical scheme, a formatting scheme, an animation scheme, a coloring scheme, a highlighting scheme, and a shading scheme.
